(19) United States
(12) Patent Application Publication
(10) Pub. No.: US 2001/0053076 A1
(43) Pub. Date: Dec. 20, 2001

(54) CONNECTOR ARRANGEMENT FOR AN ELECTRO-LUMINESCENT LIGHTING ELEMENT AND NIGHT-LIGHT USING SUCH AN ARRANGEMENT

(76) Inventor: TSENG-LU CHIEN, TAIPEILLSCNG (TW)

Correspondence Address: HOWARD C. MISKIN, C/O STOLL, MISKIN, HOFFMAN & BADIE, EMPIRE STATE BUILDING, 350 FIFTH AVE., STE. 6110, NEW YORK, NY, 10118, US

(21) Appl. No.: 09/373,623

(22) Filed: Aug. 13, 1999

Related U.S. Application Data
(63) Continuation-in-part of application No. 08/910,202, filed on Aug. 13, 1997, now Pat. No. 6,171,117.
(63) Continuation-in-part of application No. 08/383,404, filed on Feb. 3, 1995, now Pat. No. 5,667,394.

(51) Int. Cl. F21V 9/16

(52) U.S. Cl. 362/84

(57) ABSTRACT

A light includes an electro-luminescent element (14) connected to an electrical plug by conductive elements (23) in the form of flexible or elastic conductor rubber elements, or conductive elements compressed between contact areas (16) on the electrodes of the electro-luminescent element and prongs of the electrical plug.

This application is a continuation-in-part of U.S. patent application Ser. No. 08/910,202, filed Aug. 13, 1997, now allowed, which is a continuation-in-part of U.S. patent application Ser. No. 08/383,404, filed Feb. 3, 1995, now U.S. Pat. No. 5,667,394.

### BACKGROUND OF THE INVENTION

1. Field of the Invention

This invention relates to a connector arrangement for an EL lighting element, in which large area electrodes on the EL lighting element directly engage a specially designed connection member to facilitate electrical connection of the lighting element to the metal plug, thereby eliminating the need for conventional claw type or glue-type terminal arrangements, thereby simplifying assembly of the lighting element while reducing the risk of short circuits, electric shock, and sparking which could present a fire hazard. The invention also relates to an electro-luminescent lighting element for use in such a connector arrangement, and to a night light in which the connector arrangement is used.

2. Discussion of Related Art

The present invention utilizes the connector principles disclosed in parent application Ser. No. 08/383,404, now U.S. Pat. No. 5,667,394, but explicitly extends the concept to a variety of different types of electro-luminescent lighting element. Examples of EL lighting elements which may be used with the connector arrangement disclosed in the parent application and also disclosed herein are the electro-luminescent panels disclosed in U.S. Pat. Nos. 5,572,817, 5,883,508, and 5,794,366 each of which is incorporated by reference herein, as well as the three-dimensional electro-luminescent tube arrangement disclosed in copending U.S. patent application Ser. No. 08/758,393, which is also incorporated by reference herein. The connector arrangement disclosed herein may also be used with the optical device disclosed in copending U.S. patent application Ser. No. 08/841,624, also incorporated herein by reference, which is a continuation of application Ser. No. 08/489,160 (abandoned).

The description of the invention contained herein is the same as that of the parent application, except that it is clarified that the connector can be used with a number of different lighting elements, that the lighting element itself is not limited to the particular “wire” and conductive member illustrated in the description of the preferred embodiment of the invention, and in that a detailed description of a night light utilizing the principles of the invention has been added.

Basically, the invention simplifies assembly of the connector by utilizing non-penetrative contact between wide area electrodes on the electro-luminescent element and a resilient conductive member. FIGS. 4, 5A, and 5B of parent application Ser. No. 08/383,404, now U.S. Pat. No. 5,667,394, show one example of a connector utilizing these principles, and FIGS. 1B-1D, 3A, and 3B of the parent application give one example of an electro-luminescent element, referred to in the parent application as an EL strip, which may be used in the connector utilizing the principles of the invention. However, while the lighting element shown in FIGS. 1B-1D, 3A, and 3B of the parent application is especially suitable for use with the connector of FIGS. 4, 5A, and 5B of the parent application, as well as the arrangement illustrated in the present application, it will be appreciated by those skilled in the art that any electro-luminescent lighting element with appropriately configured electrodes, including those described in the above cited U.S. Pat. Nos, 5,752,337; 5,883,508; and 5,794,336, and application Ser. No. 08/758,393.

The problems with prior electro-luminescent elements per se is described in detail in the parent application, and need not be repeated herein. Instead, the following discussion relates to the particular application of a night light, which particular benefits from the principles disclosed in the parent application.

In particular, as shown in FIGS. 1 and 2, the conventional means for electrically connecting an electro-luminescent element 1 to a plug is use claw-type metal terminals 2, the teeth 3 of which are designed to penetrate the surface of electrodes or contacts on the electro-luminescent element. In the case of a night light, extensions 4 of these terminals are then connected to the prongs 5 extending through the housing 6 of a plug assembly arranged to be inserted into a wall outlet.

FIG. 3 shows an arrangement similar to that shown in FIGS. 1 and 2, with claw type terminals 7 extending from an electro-luminescent panel 8 attached to prongs 9 secured to the panel by double-sided tape 10 for use in a housing having a rear section 11, and a front section 12 having a window 13 through which the electro-luminescent panel 8 is visible to form the night light.

The problem with the use of claw type terminals, which are designed to push through the multiple layers of the electro-luminescent panel, is that the teeth on the terminals can easily cause damage to the panels during assembly, resulting in a high percentage of defective assemblies, and presenting a serious hazard of electrical shock. This is especially significant in the case of night lights, which are often placed in places where young children may have access to them.

This problem is solved in the parent application by establishing the electrical connection using a resilient conductive member to provide a self-biasing connection between connection wires and the large area terminals on the electro-luminescent element illustrated in the parent application. However, the concept of using a resilient or self-biased arrangement is not limited to the particular conductive member and wire arrangement described in the parent application, but rather can be applied in a wide variety of contexts to a wide variety of different types of electro-luminescent element, and in the case of a night light greatly reduces the above-noted safety problem presented by claw type terminals, while actually simplifying assembly because the force necessary to cause penetration is not required.

### SUMMARY OF THE INVENTION

It is accordingly an objective of the invention to provide an electro-luminescent element connector arrangement having simplified assembly and increased reliability, and which presents a reduced risk of sparking and causing a fire.

It is a further objective of the invention to provide and electro-luminescent element connector arrangement having a reduced risk of short circuits and electric shock.

It is also an objective of the invention to provide a night light utilizing an electro-luminescent element connector arrangement having simplified assembly, increased reliability, and a reduced risk of short circuits and electric shock.

These objectives of the invention are achieved, in accordance with the principles of a preferred embodiment of the invention, by providing an electro-luminescent element connector arrangement in which an electrical connection between electrodes on the electro-luminescent element and a source of electric power are provided by resilient conductive elements which provide a self-biased electrical connection to the electrodes without the need for penetrative elements or movable elements.

In the case of a night light, the objectives of the invention are achieved by providing an arrangement in which an electro-luminescent element used in the night light is connected to prongs extending from a housing of the night light by resilient conductive members compressed between contact areas on the prongs and electrodes on the electro-luminescent element or between contact areas of a circuit board containing driver circuitry and the electrodes on the electro-luminescent element.

### BRIEF DESCRIPTION OF THE DRAWINGS

FIG. 1 is an exploded perspective view of a night light having a conventional construction.

FIG. 2 is a perspective view of a claw-type terminal for use in the night light of FIG. 1.

FIG. 3 is a perspective view of a portion of a variation of the night light of FIG. 1.

FIG. 4 is a perspective view of a housing for the night light of FIG. 3.

FIG. 5 is an exploded perspective view of a night light constructed in accordance with the principles of a preferred embodiment of the invention.

FIG. 6 is an exploded perspective view of a variation of the night light of FIG. 5.

FIGS. 7 is an exploded perspective view of an electro-luminescent light assembly suitable for use in the night lights of FIGS. 5 and 6.

FIG. 8 is an exploded perspective view of a further variation of the night lights illustrated in FIGS. 5 and 6.

FIG. 9 is a perspective view of an assembled night light corresponding to the night lights illustrated in FIGS. 5 and 8.

FIG. 10 is a perspective view of an assembled night light corresponding to the night light of FIG. 6.

FIGS. 11 and 12 are, respectively, a plan view of an electro-luminescent element suitable for use in connection with the preferred embodiment of the invention, and an end view of the electro-luminescent element shown in FIG. 11.

FIG. 13A is a partially cross-sectional view of a three-dimensional electro-luminescent lighting element connected according to the principles of a preferred embodiment of the invention.

FIG. 13B is a partially cross-sectional view also illustrating an electro-luminescent lighting element constructed and connected according to the principles of a preferred embodiment of the invention.

FIG. 13C is a perspective view of a multiple element arrangement of three-dimensional electro-luminescent lighting elements of the type illustrated in FIGS. 13A and 13B, including parallel and series connections.

FIG. 13D is a perspective view of a variation of the three-dimensional electro-luminescent lighting element illustrated in FIGS. 13A and 13B, including a colored high transmitivity light tube and a purely white light emitting electro-luminescent tube.

FIG. 13E is a diagram illustrating a method of forming new terminals and repairing defective terminals according to the principles of the invention.

FIG. 13F is a block diagram illustrating a control circuit for the three-dimensional electro-luminescent lighting elements of the preferred embodiments of the invention.

FIG. 13G is a schematic circuit diagram illustrating an example of a basic circuit that could be used in connection with the three-dimensional lighting arrangements of the preferred embodiments of the invention, and which includes a transformer.

FIG. 13H is a schematic circuit diagram of an alternative circuit which could be used in connection with the three-dimensional electro-luminescent lighting elements of the preferred embodiments of the invention, and which includes and inductor.

### DETAILED DESCRIPTION OF THE PREFERRED EMBODIMENTS

As illustrated in FIG. 5, a night light constructed in accordance with the principles of a preferred embodiment of the invention includes an electro-luminescent element 14, including multiple phosphor segments 15 and electrode contact areas 16 (which are actually on the rear side of elements 16 extending from panel 14). The housing for the night light includes a rear section 17 containing an indentation for receiving the electro-luminescent element 14 and openings 18 for prongs 19, and a front section 20 having an opening or window 21 through which the electro-luminescent element is to be viewed. An optional frontsheet 22 may be positioned between the electro-luminescent element 14 and window 21.

In order to greatly simplify assembly of the night light of FIG. 5, contact areas 16 and prongs 19 are electrically connected together by means of resilient conductive elements 23 which are compressed between the contact areas and prongs when the housing is assembled together. Compression of the conductive elements 23 ensures that electrical continuity between the electrodes of the electro-luminescent element and the prongs is maintained, with the resilience of the conductive elements also compensating for tolerances in the construction of the prongs or contact areas of the electrodes of the electro-luminescent element, for example in the case where the prongs and electrodes have facing surfaces that are not completely parallel, or not completely flat.

The conductive elements 23 may be in the form of flexible or elastic conductive rubber elements, or conductive elements of similarly flexible and conductive plastic or metal material. Prongs 19 are UL-listed standard plugs, or equivalent plugs arranged to meet the requirements of countries other than the United States.

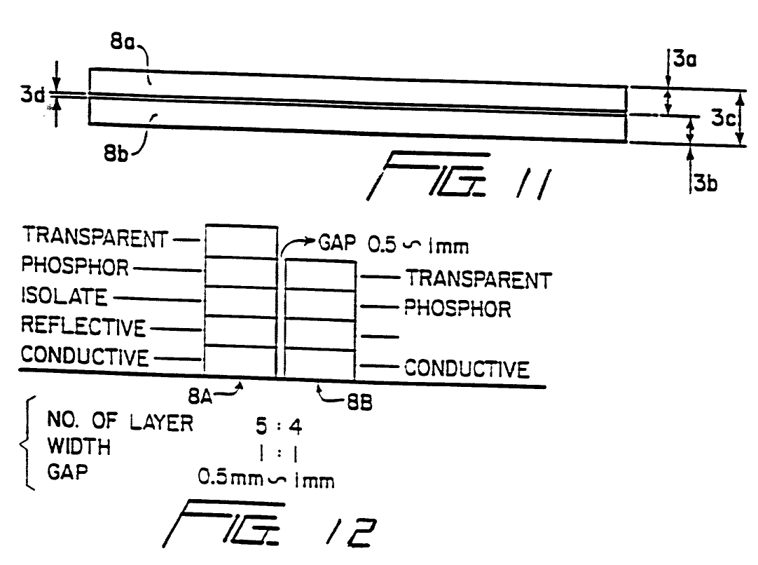

Preferably, rear housing section 17 and front housing section 20 are sealed together to prevent the night light from being opened and the electrical connections exposed. The indentation in which the electro-luminescent element is received may of course have any desired configuration, or may be eliminated in favor of alternative electro-luminescent element holding means, and the means by which the housing sections are held together and/or sealed may include any suitable holding or sealing means, including glue, double-sided tape, press-fit posts, screws, melting, ultra-sonic sealing, hot melt adhesives, etc., resulting in an attractive and compact night light assembly similar to the one illustrated in FIG. 9.

The electro-luminescent panel 14 may be of the type disclosed in U.S. Pat. Nos. 5,572,817; 5,752,337; 5,883,508; and 5,794,336; in which attractive designs are obtained by including logos, figures, cartoon characters, words, on either the frontsheet 22 or the electro-luminescent element itself, either by printing, silk-screening, stenciling, or the like, and/or by appropriately arranging the phosphor segments of the electro-luminescent element. Alternatively, or in addition to electro-luminescent panel 14 the night light may include a three-dimensional tube 14′ arranged in an attractive pattern in the manner described in copending U.S. patent application Ser. No. 08/758,393. In the embodiment illustrated in FIG. 8, for example, a single color panel 14″ provides background for the illumination effect provided by the three-dimensional electro-luminescent element 14′, the other elements of the night light being the same as described in connection with FIG. 5, except that additional conductive resilient elements, for example having the configuration illustrated in parent U.S. patent application Ser. No. 08/383,404, now U.S. Pat. No. 5,667,394, must be included in order to provide the necessary electrical connections. Further details of either the electro-luminescent panel or three-dimensional electro-luminescent element may be found in the above-cited patent and patent applications.

While in the arrangement of FIG. 5, the electro-luminescent panel is directly connected to the prongs of the night light outlet, it is also within the scope of the invention to use conductive member(s) 23′ to connect one or more electrodes of the panel to an inverter, control circuit, function interface, or the like, which can be in the form of a conventional circuit or an integrated circuit. Numerous suitable circuits are known and it is intended that the invention encompass any circuitry to which the electro-luminescent element might be connected, or no circuitry at all, with the electrodes of the electro-luminescent element being directly and exclusively connected to the prongs of the night light. By circuitry is meant any electrical component, including wires, resistors, capacitors, transistors, inductors, and so forth, as well as switches such as the illustrated photo-sensor 27.

As shown in FIGS. 6 and 10, for example, the additional circuitry might be housed in an extension 26 of the rear housing member 25. FIG. 6 also illustrates the variation in which the electro-luminescent element 26 supports retractable metal prongs but does not have multiple segments, the decorative pattern being obtained instead by appropriate decoration of the frontsheet 27.

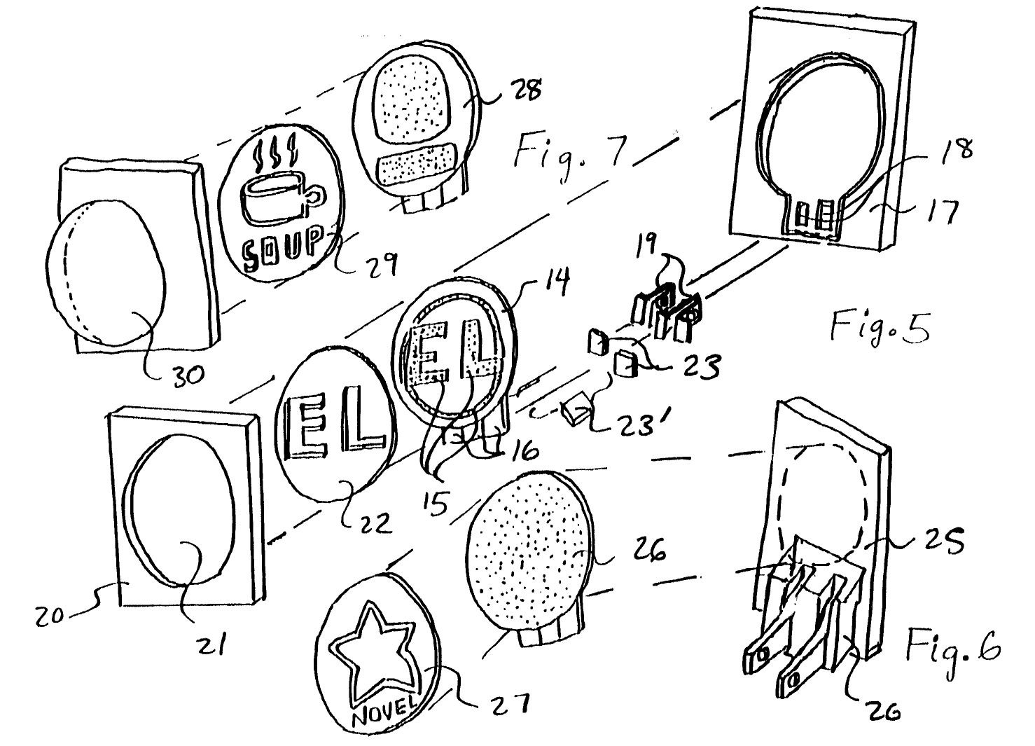

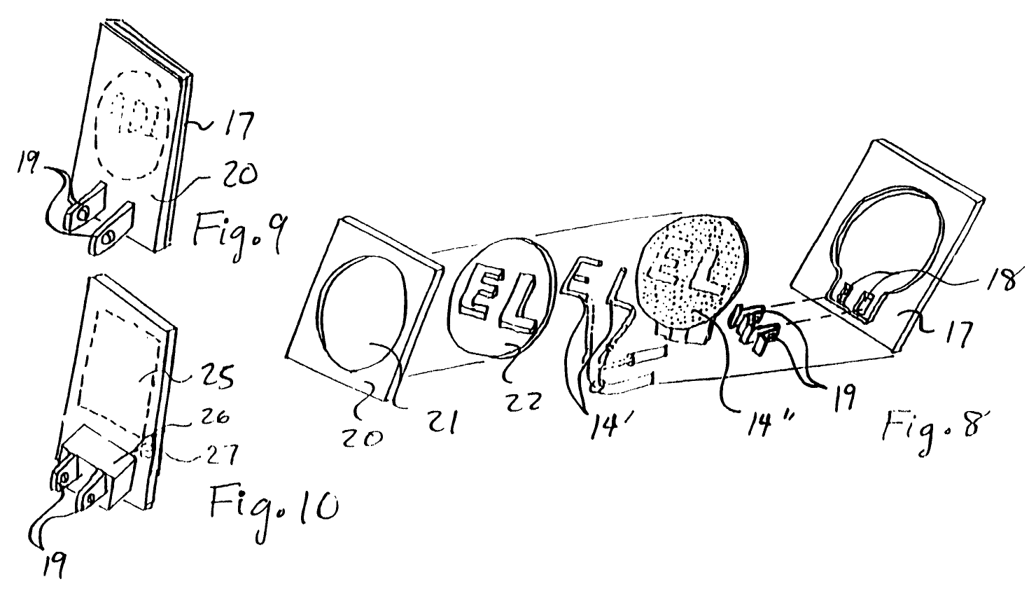

Alternatively, in the variation shown in FIG. 7, the effects obtained by electro-luminescent element 28 and frontsheet 29 are enhanced by including an optical effects device 30 similar to the one described in copending U.S. patent application Ser. No. 08/841,624 and its parent U.S. aatent application Ser. No. 08/489,160 (abandoned), in which the image of the electro-luminescent element is enhanced by passage through a transparent transmission medium such as water, a gel, a solid transparent medium, epoxy, silicone, PVC, PC, acrylic, or the like to increase the apparent brightness of the element. The optical device can form a convex or concave lens, and can magnify the image, change the image location, change the focus, or change the color of emitted light in a simple and inexpensive yet effective manner.

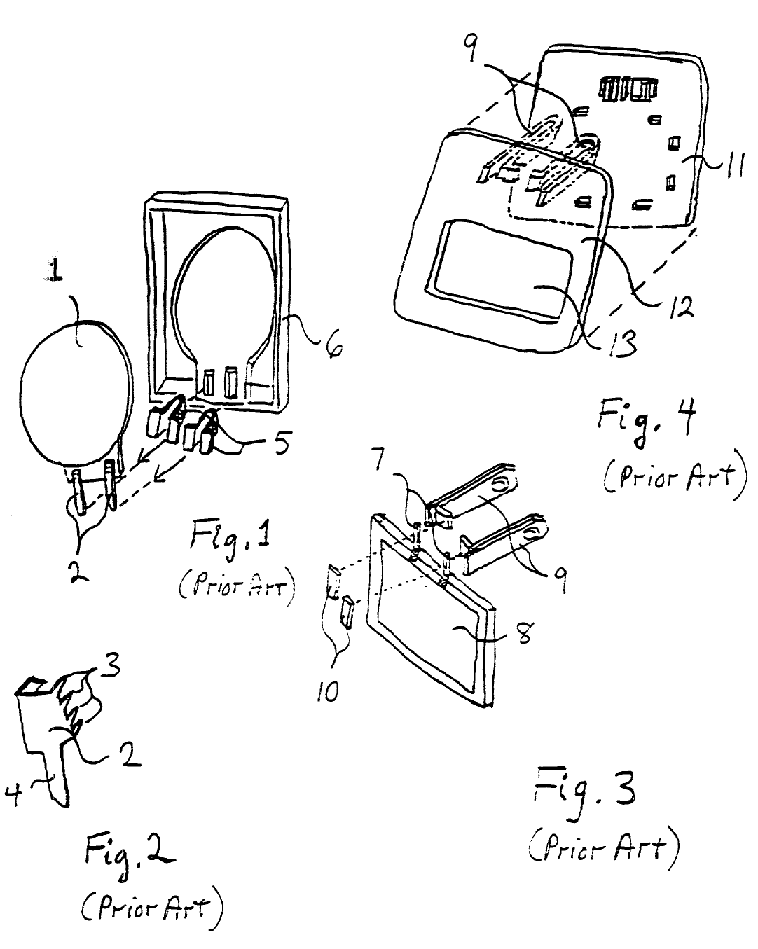

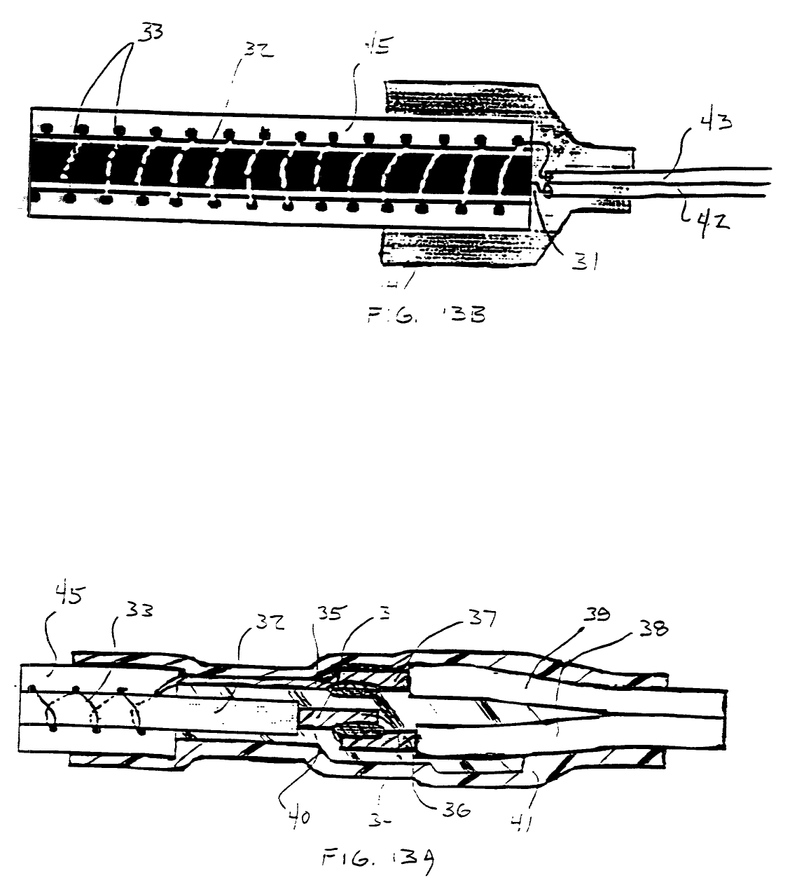

FIGS. 11 and 12, which are identical to FIGS. 3A and 3B of the parent application, show and electro-luminescent element made up of two parallel EL strip halves 8A and 8B. EL strip half 8A consists of, in order from top to bottom, a transparent conductive layer, a phosphor layer, an isolation layer, a reflective layer, and a conductive layer, while EL strip half 8B consists of, in order from top to bottom, a transparent conductive layer, a phosphor layer, an isolation layer, and a conductive layer. Each of the layers is per se identical to corresponding layers in conventional EL strips, except that the transparent conductive layer does not include an extra-width section of the type discussed in the parent application in connection with the prior art. Unlike the conventional EL strip shown in FIGS. 1A-1D of the parent application, however, electrical connection to the El strip of the preferred embodiment is accomplished by simply establishing a direct electrical connection with the respective lowermost conductive layers of the two EL strip halves, with one of the conductive layers serving as the low voltage connection and the other as the high voltage connection, and thus this strip is especially suitable for use in connection with the night lights illustrated in FIGS. 4-10.

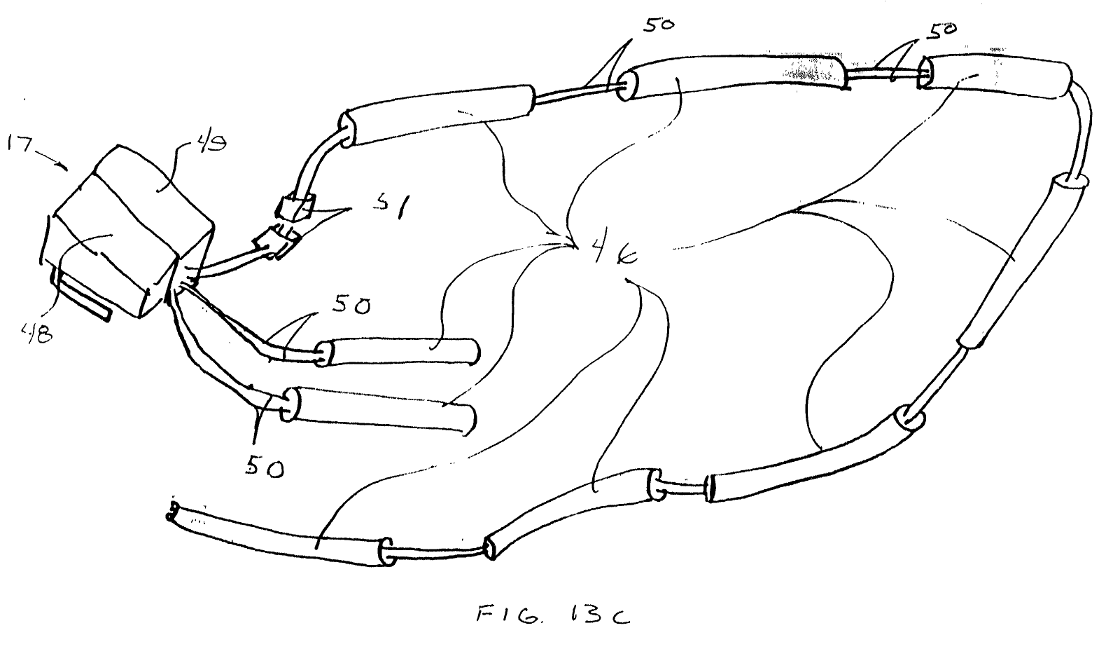

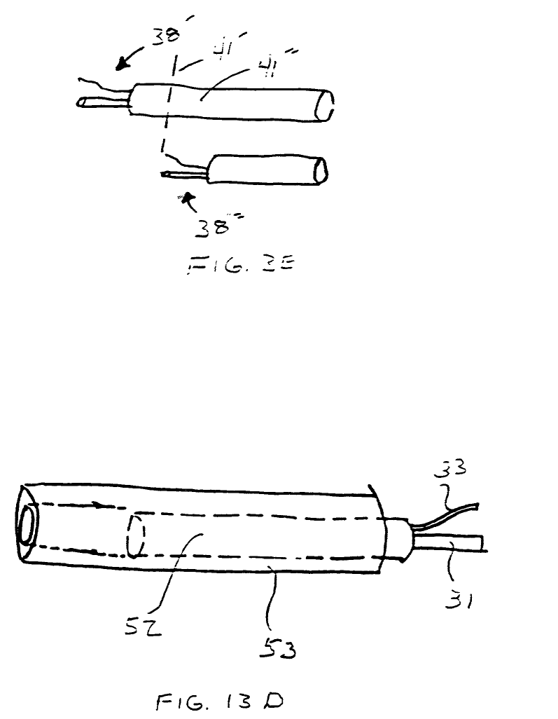

As illustrated in FIGS. 13A and 13B (from copending application Ser. No. 08/758,393) the preferred three-dimensional electro-luminescent lighting element includes a center conductor 31 surrounded by at least one set of electro-luminescent layers 32, which in turn is surrounded by an outer conductor 33.

In each of the illustrated variations of the preferred three-dimensional electro-luminescent lighting element, the center conductor 31 in the form of a metal wire or tube-shaped conductor having a diameter sufficient to carry a desired voltage and current, and may be directly coated with the phosphor layer 32, or with a dielectric layer (not shown) on which a phosphor is coated, or with multiple dielectric and/or phosphor layers using any of a variety of known layering techniques, including the techniques described, for example, in U.S. Pat. No. 5,794,336 entitled “Multiple Segment Electro-Luminescent Lighting Arrangement.” The phosphor material may either extend along the entire length of the center conductor, or along portions of the center conductor, and may consist of a single type of phosphor particle or multiple types of particles, or combinations of single and multiple particle coatings.

Surrounding the phosphor/dielectric layers 32 is the outer conductor 33 which may also be in the form of a coating or, as illustrated, a helically wound wire or coil which extends from the end of the electro-luminescent lighting element and which, along with the center conductor, or a wire attached thereto, forms the terminals for the electro-luminescent lighting element.

In the arrangement illustrated in FIG. 13A, the center conductor 31 and outer conductor 33 are soldered at ends 34 and 35 to the conductors 36 and 37 of insulated lead wires 38 and 39, which are encapsulated or otherwise separated from each other by a dielectric 40 and enclosed within a heat shrink tube 41 to form an easily handled and reliable connection, while in the arrangement illustrated in FIG. 13B, the wires of the center conductor 31 and outer conductor 33 are the respective ends of lead wires 42 and 43 which have been stripped of insulation, the point at which the lead wires exit the electro-luminescent lighting element being protected by a sleeve or bushing 44.

It will of course be appreciated that the electrical connections between the center and outer conductors and the respective leads of the element may be effected by any of a variety of methods or means, and that the leads may be attached to the center and outer conductors anywhere along the length of the element, and also at a plurality of locations along the length of the element if individual control of different segments is desired. In all such cases, connection simply involves electrical connection of wires, rather than more sophisticated pre-set terminal attachment methods required in some of the prior flat panel designs, so that new terminals can be created and defective terminals repaired or replaced simply by stripping the wires.

Finally, as shown in both FIGS. 13A and 13B, the three-dimensional electro-luminescent lighting element is surrounded by a protective outer layer 45 made of PVC or a like material. Those skilled in the art will note that, unlike the conventional flat panel, the present invention requires only a single protective layer, thereby saving materials costs and providing improved protection from moisture, over-bending, ultra-violet radiation, and other environmental hazards.

As illustrated in FIG. 13C, the leads of a plurality of electro-luminescent lighting elements 46 similar to those illustrated in FIGS. 13A and 13B may be connected directly to power pack 47 having compartments for a power supply 48 and control circuit 49, or by inexpensive electric lead wires 50 to other electro-luminescent lighting elements of similar or different colors to form chains or strings of elements, which can be connected in series or in parallel and controlled to provide a variety of different lighting effects, including flashing, steady on, chasing, random, fade in/fade out, color changing, light intensity changing, and partial length lighting effects.

While particular control circuits will be described below, those skilled in the art will appreciate that the control circuit may take a variety of forms, so long as the output of the control circuit has a frequency and voltage sufficient to trigger the electro-luminescent lighting elements by causing a varying electrical field between the center and outer conductors of each element. The power source can either include a DC power source and inverter, or an AC power source, and can be in the form of batteries, a generator, a hook-up to the power grid, or any other convenient source of electrical power. The electro-luminescent element may also be an organic electro-luminescent element.

Finally, as illustrated in FIG. 13C, some of the electro-luminescent lighting elements 36 are conveniently connected to the control circuitry by a quick disconnect electrical connector, although the electro-luminescent lighting elements could of course be wired directly to the control circuit and power supply.

Because the center conductor of the preferred three-dimensional electro-luminescent lighting element does not need to be as thin as the electrode of a flat panel, it is possible to achieve a purely white light electro-luminescent lighting element 52. This offers the possibility of surrounding the elements with masks, filters or colored elements 53 to increase the color choices provided by the elements, as illustrated in FIG. 13D. Normally, different colored electro-luminescent lighting elements require different triggering frequencies, but if the color of the element is determined by a surrounding filter, then a common electrical connection can be used for different colored elements, simplifying the wiring requirements.

The method of replacing or repairing old terminals is illustrated in FIG. 13E. Essentially, the defective terminal 38′ is simply cut-off along a cut line 41′ and the outer protective layer or layers 41″ surrounding the inner and outer conductors is stripped to thereby form new terminal 38″. In contrast, when a fixed terminal of a conventional electro-luminescent element has a manufacturing defect or is broken, repair is generally impractical and the entire element must be discarded.

Essentially, as illustrated in FIG. 13F, any electro-luminescent lighting arrangement will require some sort of power source 54, whether in the form of one or more rechargeable or non-rechargeable batteries, a generator, capacitors, the public power supply, or the like, a drive circuit 55 connected to the power source 54, the drive circuit being in the form of an inverter if the power supply is a DC power supply, a function circuit 56 for turning the electro-luminescent on and off via the drive circuit, and which may be at least partly responsive to a switch system 57, a voltage and frequency control or adjustment circuit 58 for converting the output of the drive circuit into a voltage and frequency capable of causing the electro-luminescent lighting elements 59 to emit photons.

One specific example of a suitable basic control circuit is illustrated in FIG. 13G. In this example, the control and power supply circuit includes an inductor/transformer 60, switch 61, transistor 62, three capacitors 63, and three resistors 64, connected to cause the electro-luminescent light 65 to flash or remain steady.

Alternatively, as illustrated in FIG. 13H, the control circuit could be in the form of an integrated circuit 66 capable of actuating the switch in a variety of patterns responsive to setting of a selector switch 67, a light sensitive switch 68, and/or a microphone 69, the integrated circuit supplying pulses to cause drive transistor 70 to turn on and off at an appropriate frequency and timing, with the voltage being adjusted by an inductor or transformer 71 connected between the drive transistor 40 and electro-luminescent lighting element 72.

Of course, it will be appreciated that the specific basic circuit elements illustrated in FIGS. 13G and 13H can be replaced by other circuits which perform the functions represented in FIG. 13F, for example by including in the inverter circuit a function interface having means for outputting pulses which enable the electro-luminescent lighting element to be turned on for various periods of time to provide special effects selected from the group consisting of flashing, steady-on, chasing, random, and fade-in/fade-out effects.

Similarly, it will be appreciated by those skilled in the art that the switch used in the various embodiments of the invention can include not only a manual switch, but also one or more mechanical or electric switches sensitive to conditions such as ambient light, vibrations, humidity, heat, sound, tilt, movement of a rolling ball, and so forth.

Having thus described a preferred embodiment of the invention and a number of different variations and modifications of the preferred embodiment, it is anticipated that still further variations and modifications will undoubtedly occur to those skilled in the art upon reading the above description, and it is therefore intended that the invention be interpreted solely in accordance with the appended claims.

What is claimed:

1. A night light, comprising:
at least one electro-luminescent element having oppositely facing surfaces and electrodes situated on one of said surfaces;
a plug having at least two prongs for connection to a power source;
conductive means having a first surface in contact with said electrodes and a second surface with said prongs;
a housing in which said electro-luminescent element, prongs, and conductive means are housed;
fixing means for fixing the electro-luminescent element in the housing;
assembly means for assembling said housing in such a manner that, when the housing is assembled, said conductive means is caused to securely contact said electrodes and said prongs to thereby establish an electrical connection between said electrodes and said prongs; and
wherein said electro-luminescent element is a three-dimensional electro-luminescent element.

2. A night light, comprising:
at least one electro-luminescent element having oppositely facing surfaces and electrodes situated on one of said surfaces;
a plug having at least two prongs for connection to a power source;
conductive means having a first surface in contact with said electrodes and a second surface in contact with said prongs;
a housing in which said electro-luminescent element, prongs, and conductive means are housed;
fixing means for fixing the electro-luminescent element in the housing;
assembly means for assembling said housing in such a manner that, when the housing is assembled, said conductive means is caused to securely contact said electrodes and said prongs to thereby establish an electrical connection between said electrodes and said prongs; and
an optical effects device arranged to vary an image of the electro-luminescent element and any stenciling or other indicia as perceived by a person viewing the night light.

3. A night light, comprising
at least one electro-luminescent element having oppositely facing surfaces and electrodes situated on one of said surfaces;
a plug having at least two prongs for connection to a power source;
conductive means having a first surface in contact with said electrodes and a second surface in contact with said prongs;
a housing in which said electro-luminescent element, prongs, and conductive means are housed;
fixing means for fixing the electro-luminescent element in the housing;
assembly means for assembling said housing in such a manner that, when the housing is assembled, said conductive means is caused to securely contact said electrodes and said prongs to thereby establish an electrical connection between said electrodes and said prongs; and
an inverter circuit arranged to increase a brightness, provide other lighting functions, or vary a color of the electro-luminescent element.

4. A night light as claimed in claim 3, wherein the inverter circuit includes function means in the form of a conventional circuit arranged to provide lighting functions which may be selected from the group consisting of chasing, random, fade in-out, pair flashing, time setting, time period control, and day-night control.

5. A night light, comprising:
at least one electro-luminescent element having oppositely facing surfaces and electrodes situated on one of said surfaces;
a plug having at least two prongs for connection to a power source;
conductive means having a first surface in contact with said electrodes and a second surface in contact with said prongs;
a housing in which said electro-luminescent element, prongs, and conductive means are housed;
fixing means for fixing the electro-luminescent element in the housing;
assembly means for assembling said housing in such a manner that, when the housing is assembled, said conductive means is caused to securely contact said electrodes and said prongs to thereby establish an electrical connection between said electrodes and said prongs; and
means for providing lighting functions selected from the group consisting of chasing, random, fade in-out, pair finishing, time setting, time period control, and day-night control.

6. A night light, comprising:
at least one electro-luminescent element having oppositely facing surfaces and electrodes situated on one of said surfaces;
a plug having at least two prongs for connection to a power source;
conductive means having a first surface in contact with said electrodes and a second surface in contact with said prongs;
a housing in which said electro-luminescent element, prongs, and conductive means are housed;
fixing means for fixing the electro-luminescent element in the housing;
assembly means for assembling said housing in such a manner that, when the housing is assembled, said conductive means is caused to securely contact said electrodes and said prongs to thereby establish an electrical connection between said electrodes and said prongs; and
wherein the electro-luminescent element includes retractable metal prongs.

7. An electro-luminescent (EL) light element, comprising:
first and second EL element halves each made up of a transparent conductive layer, a phosphor, an isolation layer, and a lower conductive layer, the EL element halves being separated from each other by a gap or isolation layer,
wherein the lower conductive layer of each of the halves is arranged to serve as a terminal for the respective half, one of the lower conductive layers being electrically connected to a low voltage conductor and the other to a high voltage conductor.

8. A connector arrangement for an electro-luminescent light element, comprising:
a first housing member which includes means for positioning an electro-luminescent element, means for positioning a pair of conductors, and means for positioning a pair of compressible conductive members relative to both the electro-luminescent element and the pair of conductors; and means for compressing the conductive members against conductive layers of the electro-luminescent element and against the conductors to establish an electrical connection between the conductors and the electro-luminescent element.

9. A connector arrangement as claimed in claim 8, wherein said housing members are housing members of a night light.

10. A night light, comprising,
at least one electro-luminescent element having oppositely facing surfaces and electrodes situated on one of said surfaces;
a plug having at least two prongs for connection to a power source;
conductive means having a first surface in contact with said electrodes and a second surface in contact with said prongs;
a housing in which said electro-luminescent element, prongs, and conductive means are housed;
fixing means for fixing the electro-luminescent element in the housing;
assembly means for assembling said housing in such a manner that, when the housing is assembled, said conductive means is caused to securely contact said electrodes and said prongs to thereby establish an electrical connection between said electrodes and said prongs; and
wherein said fixing means is selected from the group consisting of a wall in the housing, posts, glue, double-sided tape, and indentations or other structural features of the housing.
